(19) United States
(12) Patent Application Publication
(10) Pub. No.: US 2025/0155471 A1
(43) Pub. Date: May 15, 2025

(54) TECHNOLOGIES FOR PHOTOTHERMAL ACTION-BASED TWO-DIMENSIONAL INFRARED SPECTROSCOPY WITH HIGH SPATIAL RESOLUTION

(71) Applicant: Lehigh University, Bethlehem, PA (US)

(72) Inventors: Xiaoji XU, Center Valley, PA (US); Qing XIE, Bethlehem, PA (US)

(73) Assignee: Lehigh University, Bethlehem, PA (US)

(21) Appl. No.: 18/948,387

(22) Filed: Nov. 14, 2024

Related U.S. Application Data
(60) Provisional application No. 63/598,635, filed on Nov. 14, 2023.

(51) Int. Cl. G01Q 30/02; G01N 21/35; G01Q 60/34

(52) U.S. Cl. CPC G01Q 30/02; G01N 21/35; G01Q 60/34; G01N 2021/3595; G01N 2201/06113

(57) ABSTRACT

Technologies for atomic force microscopy (AFM)-based photothermal two-dimensional infrared (2DIR) spectroscopy are disclosed. Techniques may comprise providing pulsed light from an infrared (IR) laser source. A pulse sequence may be generated from the IR light. The pulse sequence may comprise one or more time delays among constituent pulses. The pulsed IR light may be focused on matter in a sample region. The pulsed IR light may interact with the matter in the sample region. One or more photothermal expansion mechanical actions in the matter of the sample region may be measured. One or more signals corresponding to the one or more measured photothermal expansion actions may be created and may be recorded as a function of the one or more time delays. A photothermal two-dimensional (2D) spectrum may be extracted from the one or more signals as recorded as a function of the one or more time delays.

### CROSS-REFERENCE TO RELATED APPLICATIONS

This application claims the benefit of U.S. Provisional Patent Application No. 63/598,635, filed on Nov. 14, 2023, the entire disclosure of which being hereby incorporated by reference herein, for all purposes.

### BACKGROUND

Atomic force microscopy (AFM) is a type of scanning probe microscopy (SPM) with high spatial resolution. AFM typically uses a sharp tip at the end of a cantilever to measure the sample surface. AFM has demonstrated resolution on the order of fractions of a nanometer, perhaps for example more than 1000 times better than the optical diffraction limit.

AFM has three major abilities: force measurement, topographic imaging, and manipulation. In force measurement, AFMs can be used to measure the forces between the probe and a sample as a function of their mutual separation. This can be applied to perform force spectroscopy, to measure the mechanical properties of the sample, such as the sample's Young's modulus, a measure of stiffness. For imaging, the reaction of the probe to the forces that the sample imposes on it can be used to form an image of the three-dimensional shape (topography) of a sample surface at a high resolution. In manipulation, the forces between a tip and sample can also be used to change the properties of the sample in a controlled way. Examples of this include atomic manipulation, scanning probe lithography, and/or local stimulation of cells.

### BRIEF SUMMARY

Technologies are disclosed for techniques, methods, devices, and/or systems for performing atomic force microscopy (AFM)-based photothermal action-based two-dimensional infrared (2DIR) spectroscopy (AFM-2DIR). One or more techniques may comprise providing IR light pulses from an infrared (IR) laser source. One or more techniques may comprise generating a pulse sequence from the IR light via a sequencer device. The pulse sequence may comprise one or more time delays among one or more constituent pulses. One or more techniques may comprise focusing the pulsed IR light on matter in a sample region. The pulsed IR light may interact with the matter in the sample region. One or more techniques may comprise measuring one or more photothermal expansion mechanical actions in the matter of the sample region. One or more techniques may comprise creating one or more signals corresponding to the one or more measured photothermal expansion mechanical actions. One or more techniques may comprise recording the one or more signals as a function of the one or more time delays. One or more techniques may comprise extracting at least a partial photothermal two-dimensional (2D) spectrum from the one or more signals as recorded as a function of the one or more time delays.

Technologies may comprise systems and/or devices for performing photothermal action-based two-dimensional infrared (2DIR) spectroscopy. The action detection may be done by an atomic force microscope (AFM). One or more devices/systems may comprise an infrared (IR) laser source configured to provide IR light pulses. One or more devices/systems may comprise a sequencer device configured to generate a pulse sequence from the IR light. The pulse sequence may comprise one or more time delays among one or more constituent pulses. One or more devices/systems may comprise optics configured to focus the pulsed IR light on matter in a sample region. The pulsed IR light may interact with the matter in the sample region. One or more devices/systems may comprise a detection device configured to measure one or more photothermal expansion mechanical actions of the sample. One or more devices/systems may comprise a computing device. The computing device may comprise a memory and/or a processor. The processor may be configured to detect the measured one or more photothermal expansion mechanical actions. The processor may be configured to create one or more signals corresponding to the one or more measured photothermal expansion mechanical actions. The processor may be configured to record the one or more signals as a function of the one or more time delays. The processor may be configured to extract at least a partial photothermal two-dimensional (2D) spectrum from the one or more signals as recorded as a function of the one or more time delays.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The elements and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1A is a block diagram illustrating the general arrangement of AFM-2DIR components.

FIG. 1B to FIG. 1D is an illustration of example signal processing of AFM-2DIR.

FIG. 1E and FIG. 1F is an illustration of example of interferograms of AFM-2DIR spectroscopy.

FIG. 1G illustrates an example spectrum of AFM-2DIR.

FIG. 2 is an illustration of example 2D PFIR spectrum of carbonyl of PMMA-N₃.

FIG. 3 is a block diagram of a hardware configuration of an example device that may control one or more parts of an AFM-2DIR of FIG. 1A.

FIG. 4A to FIG. 4D illustrates an example of AFM-2DIR measurement of an h-¹⁰BN flake for studying energy transfer processes.

FIG. 5A and FIG. 5B illustrates a block diagram of an example technique/process for performing photothermal action-based two-dimensional infrared (2DIR) spectroscopy with AFM.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of this disclosure is thereby intended.

AFM usually gives the topography of a sample at a high spatial resolution. The disadvantage is that the topography, that is, the shape of the sample surface, does not convey the information of the chemical compositions. As an extension of the AFM technique, atomic force microscopy-infrared spectroscopy (AFM-IR) was developed. In AFM-IR, the mechanical action of the photothermal expansion of the sample is detected by the AFM's tip, which causes the AFM's cantilever to bend or oscillate. Such photothermal induced mechanical action (abbreviated as “photothermal action”) is infrared (IR) wavelength dependent. When the IR light matches the resonances of the sample, the photothermal action is enhanced. By scanning the wavelength of narrowband IR sources and recording the photothermal action from the AFM's cantilever bending or oscillation amplitude, a photothermal action-based AFM-IR spectrum is obtained. Such an AFM-IR spectrum is one-dimensional and usually indicates the sample's local composition underneath the sharp AFM tip. The collection of AFM-IR is not restricted by the optical diffraction limit on its spatial resolution. An IR spectrum from the AFM-IR usually resembles that of an IR spectrum from a regular Fourier transform infrared (FTIR) spectroscopy on the same chemical composition.

FTIR spectroscopy is widely used for fast chemical identification by providing a useful one-dimensional spectrum to indicate the IR resonance of the sample. One limitation of the FTIR is spectral congestion, which occurs when the sampling area contains different chemical components with overlapping spectral peaks in the same spectrum. These overlapping spectral peaks can make the clear assignment of resonance peaks difficult, reducing the ability of IR spectroscopy to identify unknown samples' chemical compositions. One IR spectroscopy method to avoid spectral congestion is to employ time-domain two-dimensional infrared (abbreviated as 2DIR) spectroscopy. The time-domain 2DIR spectroscopy utilizes a sequence of femtosecond IR pulse excitations and detects the attenuation of the IR beam with optical detections, i.e., detecting IR photons. The 2DIR technique resolves spectral congestion in regular IR by expanding the spectroscopic responses into a 2D frequency-frequency map. Overlapping spectral peaks in the one-dimensional FTIR spectrum are more likely to be resolvable in the 2DIR spectrum. Moreover, 2DIR spectroscopy is found to be useful in revealing mode anharmonicity and energy transfers, which are not easily resolvable from the one-dimensional FTIR spectrum. However, 2DIR spectroscopy with optical detection has a low spatial resolution, usually bound by the optical diffraction limit as it involves the optical detection of IR photons.

Infrared (IR) spectroscopy has advanced on two distinct frontiers: enhancing spatial resolution and broadening spectroscopic information. While atomic force microscopy (AFM)—based IR microscopy reaches sub-10 nm spatial resolutions, not restricted by the optical diffraction limit, femtosecond two-dimensional IR spectroscopy (2DIR) provides unparalleled insights into molecular structures, mode coupling, and energy transfers. These two realms, however, evolved separately. Their gap may be bridged by introducing AFM-2DIR spectroscopy that utilizes mechanical detection of the sample's photothermal responses from tip-enhanced femtosecond (fs) IR pulse sequences. This innovative approach offers the spatial precision of AFM with the rich spectroscopic depth of 2DIR. The feasibility may be demonstrated on the carbonyl vibrational mode, elucidating its anharmonicity. Further, leveraging the AFM tip's near-field photons' high momenta for phase matching, consider photothermally probe hyperbolic phonon polaritons (PhPs) in isotope-enriched h-¹⁰BN. The measurement confirms energy transfers between PhPs and phonons as well as among polariton modes, possibly aided by edge scattering. The AFM-2DIR technique promises nanoscale insights into molecular anharmonicity, mode coupling, and energy transfers in heterogeneous materials and nanostructures.

Under light illumination, a sharp metal-coated tip of an atomic force microscope (AFM) localizes and enhances the optical field underneath its tip apex. The spatial scale of the tip enhancement is comparable to the tip radius and effectively wavelength-independent, thus bypasses Abbe's diffraction limit. Capitalizing on tip enhancement, innovative AFM-based super-resolution spectroscopic imaging tools have been developed. Notable among these are scattering-type scanning near-field optical microscopy (s-SNOM) and photothermal action-based AFM-IR microscopy. Furthermore, photons in the non-propagating near-field of tip-enhancement possess high spatial frequencies. This indicates they carry a momentum much greater than what the dispersion relation of free space photons would typically allow. For instance, momentum in the ultraviolet and energy in the mid infrared (IR) are needed for the formation of phonon polariton (PhP). The tip-based s-SNOM and AFM-IR have been utilized to launch and detect PhPs in low dimensional materials.

IR photons are widely used in spectroscopy because they match molecular vibrational modes and phonons of crystals. One frontier of IR spectroscopy is the time-domain two-dimensional IR (2DIR) spectroscopy, by utilizing short duration and broad bandwidth of femtosecond IR pulses. Several IR-active modes can be coherently excited and probed by a designed IR pulse sequence. 2DIR spectroscopy delivers rich information vibrational modes, revealing anharmonicities, mode coupling, and energy transfer. Modern 2DIR techniques are restricted by the optical diffraction limit, which causes poor spatial resolution in the mid-IR frequency, despite the abundance of spectroscopic information.

The integration of AFM's tip-enhancement with 2DIR would overcome the diffraction limit, enabling the spatial resolution to reach nanometer-scale. However, despite steady progress in s-SNOM-based time-resolved pump-probe near-field spectroscopy, the integration of AFM with 2DIR still remains under explored. An advancement in nanoscale IR spectroscopy may combine the photothermal AFM-IR with 2DIR. The resulting AFM-2DIR employs a sharp metallic AFM tip to mechanically detect the photothermal response of a sample triggered by a tip-enhanced femtosecond IR pulse sequence. The relative timings between the IR pulses in the sequence are systematically scanned, and the corresponding modulations in the photothermal signal are recorded. As a demonstration, method/techniques may uncover the anharmonicity of the carbonyl vibrational mode and to elucidate the possible energy transfer pathways of PhP in hexagonal boron nitride (h-¹⁰BN).

The strong phonon and hyperbolic dispersion in the mid-IR make h-BN a natural two-dimensional material supporting hyperbolic PhPs which are capable of travelling within the material with high field strength and high confinement. Because of the restriction from phase matching condition, PhP in h-BN cannot be efficiently generated by far-field IR illumination. Instead, they are usually studied by IR s-SNOM, and to less extent, the AFM-IR techniques. These AFM-based imaging tools visualize the spatial distributions of interference fringes resulting from standing waves of propagating PhPs between the tip launching site and boundary reflections of the material. In s-SNOM, forming standing waves alter the light scattering ability of the metallic tip, modifying the scattered amplitude and phase; in AFM-IR, the metallic tip measures the photothermal expansion from relaxation of PhP, which spatially coincide with the distribution of standing wave modes that enhance the IR absorptions.

While PhPs of h-BN have immense potential for applications including confined optical energy delivery, subwavelength imaging, and chemical sensing, gaps remain in the understanding of their relaxation process. In principle, relaxation involves energy transfer from initial excited states or resonances to other degrees of freedom and eventually becomes heat. When the direct radiative decay is finite, the principal dissipation route of phonon polaritons is believed to be through non-radiative phonon scattering, i.e., interactions with phonons in the lattice that facilitate energy transfer. However, there is yet an experimental tool to directly probe energy transfer among the phonon and PhP modes. In one or more scenarios, the photothermal AFM-2DIR spectroscopy, seeks to fill this gap.

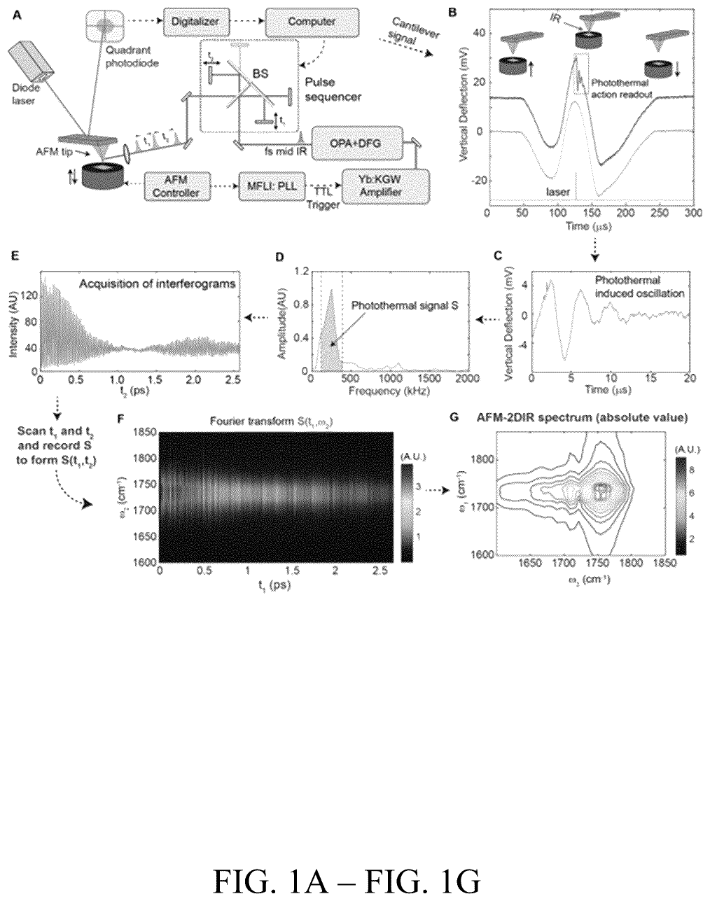

The construction of the apparatus is described herein. In short, the AFM-2DIR apparatus (FIG. 1A) comprises three main components: the generation of a femtosecond IR pulse sequence, an AFM with a metallic probe, and a signal extraction mechanism to register the photothermal signal. For example, utilization of a temperature-regulated compact assembly of Michelson interferometers (that is, the pulse sequencer, marked by the dashed box) to generate a collinear time-controlled sequence of IR pulses from a 200 fs duration femtosecond IR radiation, generated from difference frequency generation (DFG) of optical parametric amplifier (OPA) of a Yb:KGW laser amplifier. The pulse sequence is composed of three pulses with t₁ standing for the time separation between the first and second pulses and t₂ for the second and third pulses. A parabolic mirror focuses the IR pulse sequence at the tip of the AFM. The timing t₁ and t₂ are scanned during the AFM-2DIR measurement while recording the photothermal signal.

The photothermal signal is generated and extracted following the mechanism of the peak force infrared (PFIR) microscopy, an emerging AFM-IR technique with <10 nm spatial resolution and works well with low repetition light source. Using PFIR, the AFM is operated under peak force tapping (PFT) mode, in which the AFM tip intermittently and predicably contacts and detaches from the sample surface. The Yb:KGW laser amplifier is triggered at the PFT frequency through a phase-locked loop (PLL), so that the emission of IR is synchronized with the moment when the tip and the sample are in contact (FIG. 1). Then, the sample's IR resonances, excited by the tip-enhanced IR pulse sequence and subsequently relaxed in a picosecond scale, generate heat for photothermal responses at the microsecond scale. It induces the rapid thermal expansion of the sample underneath the tip which exerts an impulsive force and excites AFM's cantilever to oscillate at hundreds of kHz (FIG. 1C) read out by the vertical deflection signal from a built-in quadrant photodiode and acquired by a digitizer. Fourier transform (FFT) retrieves the amplitude of the cantilever oscillation, which is integrated in a frequency window and used as the photothermal signal S (FIG. 1D).

The collective absorption of the IR pulse sequence and subsequent non-radiative decay contributes to the photothermal signal. The time separations t₁ and t₂ between the pulses in the sequence influence which states and how they are populated, thus causing modulations of the photothermal signal. In a simple picture, the first two pulses are considered as the pump. The temporal separation t₁ determines which subset of IR frequencies within the IR bandwidth is utilized to populate vibrational states. The third pulse acts as the probe, the absorption of which is modified by existing excited states prepared by the pump. Besides linear IR absorption, more complex light-matter interaction pathways, such as the excited state absorption, mode coupling and energy transfer are modulated by the timings of t₁ and t₂ of the pulse sequence.

In one or more measurements, a series of interferograms is collected by sequentially scanning the time delays of t₁ and t₂ and recording the photothermal PFIR signal S. FIG. 1E displays an interferogram by scanning t₂ at a fixed t₁. Stepwise scanning t₁ and collecting corresponding interferograms of t₂ form a two-dimensional interferogram S(t₁, t₂). Sequential FFTs are used to convert S(t₁, t₂) into frequency domains S(ω₁, ω₂). FIG. 1F displays a spectrogram S(t₁, ω₂) from FFT of S(t₁, t₂) along the fast scan axis of t₂. Additional Fourier transform is performed along t₁ to obtain a 2D spectrum of S(ω₁, ω₂). S(ω₁, ω₂) is named as the AFM-2DIR spectrum. Because the AFM-2DIR spectrum is obtained by the PFIR detection mechanism. It is also called 2D PFIR spectrum.

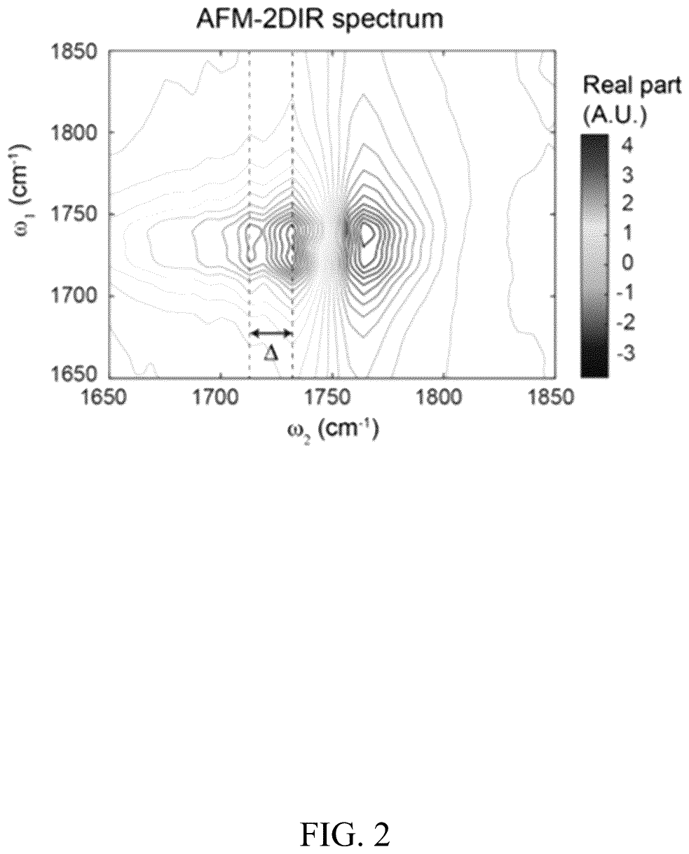

Revealing anharmonicity of carbonyl vibrational mode by AFM-2DIR detection may be conducted. An absolute-part AFM-2DIR spectrum of carbonyl vibrational modes of a 50 nm thick PMMA-N₃ polymer film is displayed in FIG. 1G. Excited state absorption can be discerned from the extended tail along low frequency of t₂. The AFM-2DIR spectrum is usually complex valued. An informational visualization of AFM-2DIR spectrum is to separately represent its real or imaginary parts. FIG. 2 is the real-part plot of the 2D PFIR spectrum. The excited state absorption overtone is clearly visualized in the real part of the 2D spectrum. The distance between the features of excited state absorption and its overtone reveals anharmonicity Δ of ˜19 cm⁻¹. Note that the relatively large anharmonicity reflects the condensed phase carbonyl under the tip enhancement.

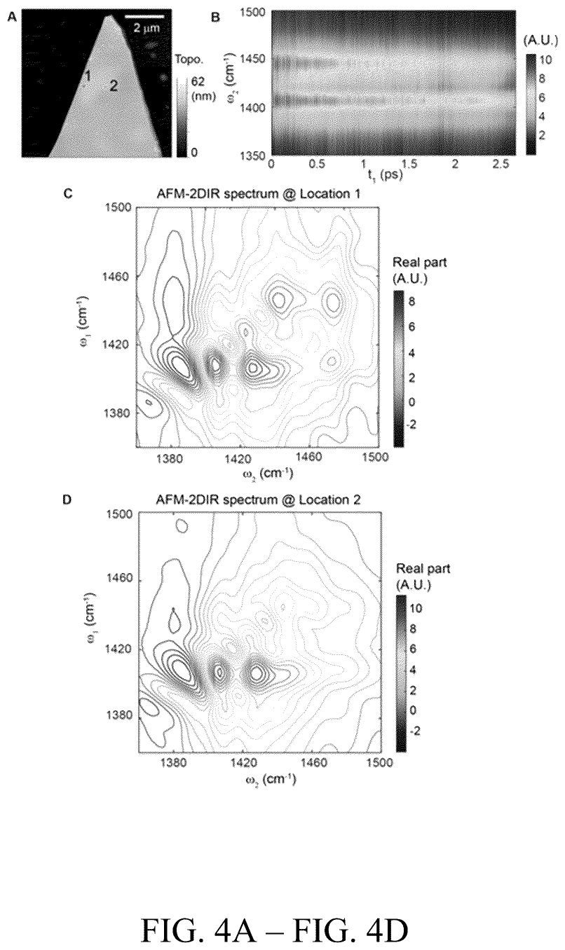

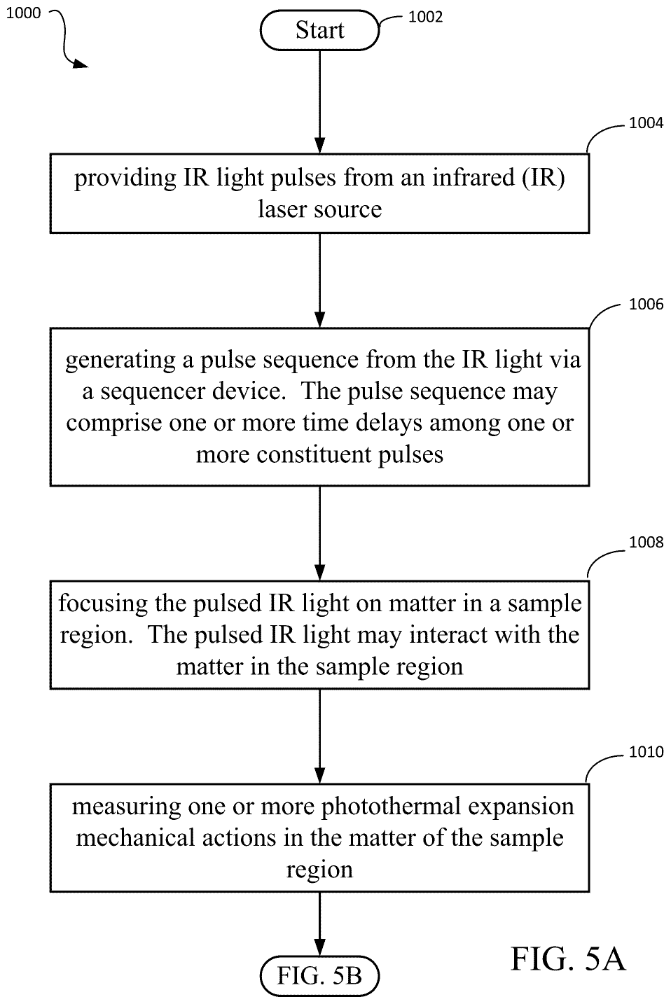

FIG. 4A to FIG. 4D displays the AFM-2DIR measurement of an isotope-enriched h-¹⁰BN flake for probing energy transfer processes. Performance of measurements on two locations 1 and 2 may be done, marked in the AFM topography (FIG. 4A). They are located 200 nm and 1500 nm from the left edge of the flake, respectively. The AFM-2DIR measurements may be performed by scanning t₁ and t₂ to collect series of interferograms. Performing Fourier transform along one time delay scan yields a spectrogram. The spectrogram of S(t₁, ω₂) of Location 1 is presented in FIG. 4B, which exhibits a decay trend on the interference contrast along t₁. The real part of the AFM-2DIR spectra of two locations are displayed in FIGS. 4C and 4D. The overall spectral profile of h-¹⁰BN is different from that of the carbonyl, because the polariton resonances are determined by the phase matching conditions and tip-edge standing wave condition. The difference of AFM-2DIR spectra from FIGS. 4C and 4D proves that the AFM-2DIR spectroscopy is spatially sensitive.

In 2D spectroscopy, off-diagonal spectral responses reveal coupling and/or energy transfers between resonances. Mode coupling usually results in nearly symmetric distributions of the off-diagonal response along the diagonal line, because mode coupling is an intrinsic component in the Hamiltonian of molecules. In contrast, energy transfers from one mode to another do not intrinsically exhibit diagonal symmetry, and the positions of the asymmetry are used to deduce the energy transfer directions. Predominantly asymmetrical distribution may be observed of the off-diagonal responses in FIGS. 4C and 4D, revealing energy transfers among resonant modes. Notably more energy transfers happens at Location 1, because Location 1 is closer to the edge of the h-¹⁰BN that may serves as scattering site for energy transfer than Location 2.

From perspective of method development, demonstration of the first photothermal AFM-2DIR spectroscopy through integration of PFIR signal detection with an IR pulse sequence may be done. The AFM's tip detection naturally bypasses the diffraction limit and provides high spatial precision, about three orders of magnitude better than regular 2DIR spectroscopy. The AFM-2DIR technique operates under ambient conditions and does not require special sample treatment or extrinsic labels, thus should be widely applicable to surface analysis of heterogeneous materials across disciplines.

Further improvement of the method may benefit from the utilization of a pulse shaper to generate ultra phase-stable pulse sequence at a faster scan speed than an interferometer. A direct extension of this method may involve using four pulses for the excitation sequence, i.e., the introduction of a wait time r between t₁ and t₂ to further decipher the time-resolved energy transfer processes. Similar signal generation and detection mechanism should also be applicable for the visible frequency range, thus allowing in situ study of electronic transitions in photovoltaics and plasmons in nanostructures.

Details of the experimental setup and operation procedures of AFM-2DIR apparatus are described as follows. The AFM-2DIR apparatus (FIG. 1A) comprises three main components: the optical assembly for generating a femtosecond IR pulse sequence, an AFM with a metallic tip for field enhancement, and a signal extraction mechanism to register the photothermal signal. Femtosecond IR pulses of 200 fs duration may be generated from the difference frequency generation (DFG) of an optical parametric amplifier (OPA, Orpheus with DFG II option, Light Conversion), pumped by a Yb:KGW amplifier (Pharos, Light Conversion) centered at 1030 nm of 190 fs duration. The IR beam was collinear with a He—Ne alignment laser to facilitate the beam alignment. The IR pulse sequence was generated from a compact assembly of three Michelson interferometers with coated CaF₂ beam splitters (BSW511R, Thorlabs) built on a single piece of a temperature-regulated aluminum plate under an enclosure. The temperature of the interferometers was regulated by a PID controller (TC200, Thorlabs) connected to a resistive foil heater (HT10K, Thorlabs) underneath the aluminum plate. The temperature of the setpoint was ˜1 degree Celsius above the room temperature. The optical path of the interferometer arms was about 8 cm. The interferometer assembly created up to four independent time-delayed IR pulses from one IR input. Three of the IR pulses may be used in one or more measurements. The relative timing between the first and second pulses was denoted as t₁, scanned stepwise by a step motor (ZFS25B, Thorlabs). The timing between the second and third pulses was denoted as t₂, which was scanned under the constant velocity mode by a direct-drive motor (DDMS100, Thorlabs). The output pulse sequence was guided into the tip-sample region of the AFM (Multimode 8, Bruker) with a parabolic mirror of 25 mm focal length.

The photothermal action signal extraction mechanism similar to the PFIR microscopy may be employed to collect the sample's photothermal signal from the tip-enhanced IR pulse sequence (FIG. 1B to 1D). In PFIR operation, the AFM was operated under the peak force tapping (PFT) mode at 2 kHz. It was guided to a phase-locked loop (PLL) of a lock-in amplifier (MFLi-MF, Zurich Instrument). The output TTL from the PLL triggered a function generator (HDG2012B, Hantek) to generate a suitable trigger waveform for the laser emission of the Pharos laser amplifier. Adjustment of the phase of the PLL may be done so that the IR laser illumination was synchronized to the moment when the tip and the sample may be in contact (FIG. 1B). A Pt-coated AFM tip (5 N/m, HQ:NSC/Pt 14, MikroMasch) was used. The highly localized light field induced the enhanced IR absorption from sample underneath the tip. The relaxation of IR absorption caused rapid thermal expansion of the sample surface within a microsecond. As a result, the expansion excited the tip and its cantilever to oscillate at hundreds of kHz shown in FIG. 1C. The cantilever's oscillations may be read out through a built-in quadrant photodiode and sent to a digitizer (PXI-5122, National Instrument) with a data acquisition rate of 50 MHz and an average number of 64. The integrated amplitude of the cantilever oscillation after the FFT was registered as the photothermal signal S in FIG. 1D. A series of interferograms may be collected by sequentially scanning the time delays of t₂ and t₁ and recorded the photothermal PFIR signal S. FIG. 1E displayed an interferogram by scanning t₂ at constant velocity (15 μm/s) at a fixed t₁. The scan range for t₂ was set to 400 μm (beam traveled 800 μm). Scanned t₁ at a constant step size (500 nm/step) and collected corresponding interferograms from t₂ to form a two-dimensional interferogram S(t₁, t₂) may be done. Sequential Fourier Transforms (FFTs) may be applied to convert S(t₁, t₂) into frequency domains S(ω₁, ω₂).

Operation flow of the AFM-2DIR method with the PFIR detection. FIG. 1A illustrates example schematics of the experimental apparatus. FIG. 1B illustrates an example of vertical deflection signals of the AFM cantilever with (red) and without (blue) laser illuminations. The IR pulse sequence arrives when the AFM tip and sample are in contact. The additional cantilever oscillations are due to sample's photothermal expansion (dashed box). FIG. 1C illustrates the extracted photothermal induced oscillation after removing the slow varying curvature of the AFM cantilever through polynomial fitting (e.g., at the 4th order). FIG. 1D illustrates an example of Fourier transformation of the extracted cantilever oscillations. The area across the mechanical resonance is integrated and used as the photothermal signal S. FIG. 1E illustrates example interferograms are collected by fast scanning the time delay t₂ at each t₁ step. FIG. 1F illustrates example spectrogram(s) obtained from Fourier transform of the interferogram along t₂ into the frequency domain CO₂ under each t₁. FIG. 1G illustrates example AFM-2DIR spectrum obtained from subsequent Fourier transform on t₁. The absolute value of the 2D spectrum is shown in FIG. 1G.

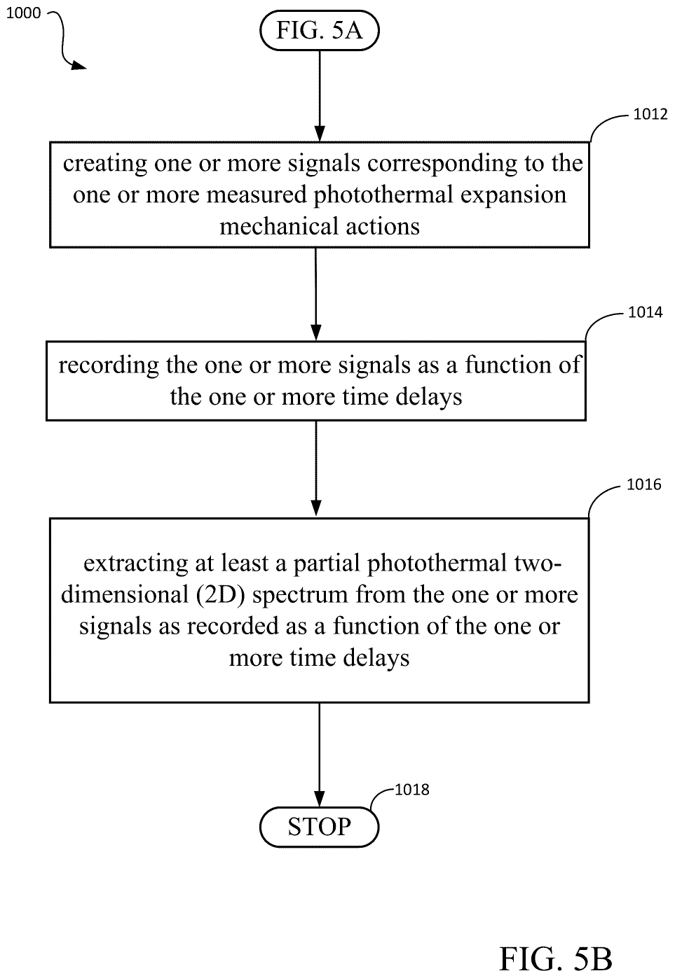

Referring now to FIG. 5A and FIG. 5B, a diagram 1000 illustrates an example technique/process for performing photothermal action-based two-dimensional infrared spectroscopy by atomic force microscope (AFM-2DIR). The method may be performed by one or more of the components of the AFM-2DIR system of FIG. 1A, among other devices. At 1002, the process may start or restart.

At 1004, methods may comprise providing IR light pulses from an infrared (IR) laser source. At 1006, methods may comprise generating a pulse sequence from the IR light via a sequencer device. The pulse sequence may comprise one or more time delays among one or more constituent pulses.

At 1008, methods may comprise focusing the pulsed IR light on matter in a sample region. The pulsed IR light may interact with the matter in the sample region. At 1010, methods may comprise measuring one or more photothermal expansion mechanical actions in the matter of the sample region.

At 1012, methods may comprise creating one or more signals corresponding to the one or more measured photothermal expansion mechanical actions. At 1014, methods may comprise recording the one or more signals as a function of the one or more time delays. At 1016, method may comprise extracting at least a partial photothermal two-dimensional (2D) spectrum from the one or more signals as recorded as a function of the one or more time delays. At 1018, the technique/process may stop or restart.

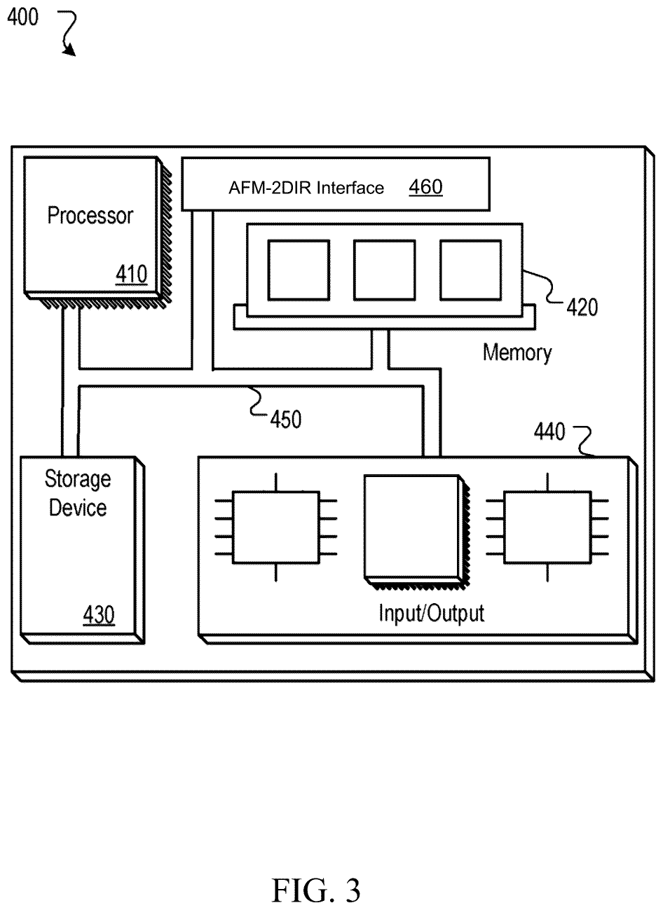

FIG. 3 is a block diagram of a hardware configuration of an example device that may function as a process control device/logic controller, such as for any of the components of the AFM-2DIR of FIG. 1A. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be a single-core processor or the processor 410 can be a multi-core processor. The processor 410 can be capable of processing instructions stored in the memory 420 and/or on the storage device 430. The processor 410 may be CPU, GPU, a hardware decoder(s) (e.g., for JPEG hardware decoder).

The memory 420 can store information within the hardware configuration 400. The memory 420 can be a computer-readable medium (CRM), for example, a non-transitory CRM. The memory 420 can be a volatile memory unit, and/or can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks. The input/output device 400 may be in communication with one or more input/output modules (not shown) that may be proximate to the hardware configuration 400 and/or may be remote from the hardware configuration 400. The one or more output modules may provide input/output functionality in the digital signal form, discrete signal form, TTL form, analog signal form, serial communication protocol, fieldbus protocol communication and/or other open or proprietary communication protocol, and/or the like.

The AFM-2DIR interface 460 may provide digital video input/output capability and other interface/communication/control for the hardware configuration 400 regarding the AFM-2DIR of FIG. 1A, in addition to the other elements of hardware configuration 400. The AFM-2DIR interface 460 may communicate with any of the elements of the hardware configuration 400, perhaps for example via system bus 450. The AFM-2DIR interface 460 may be in wired and/or wireless communication with the hardware configuration 400. In one or more scenarios, the AFM-2DIR interface 460 may be external to the hardware configuration 400. In one or more scenarios, the AFM-2DIR interface 460 may be internal to the hardware configuration 400.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

In view of FIG. 1A to FIG. 5B, one or more techniques, processes, systems, devices for performing photothermal action-based two-dimensional infrared (2DIR) spectroscopy. One or more techniques may comprise providing IR light pulses from an infrared (IR) laser source. One or more techniques may comprise generating a pulse sequence from the IR light via a sequencer device. The pulse sequence may comprise one or more time delays among one or more constituent pulses. One or more techniques may comprise focusing the pulsed IR light on matter in a sample region. The pulsed IR light may interact with the matter in the sample region. One or more techniques may comprise measuring one or more photothermal expansion mechanical actions in the matter of the sample region. One or more techniques may comprise creating one or more signals corresponding to the one or more measured photothermal expansion mechanical actions. One or more techniques may comprise recording the one or more signals as a function of the one or more time delays. One or more techniques may comprise extracting at least a partial photothermal two-dimensional (2D) spectrum from the one or more signals as recorded as a function of the one or more time delays.

In one or more scenarios, one or more techniques may comprise detecting the one or more mechanical actions of the photothermal expansion on matter by an atomic force microscope via tip-sample contact.

In one or more scenarios, one or more techniques may comprise detecting the one or more mechanical actions of the photothermal expansion on matter via at least one of: an atomic force microscope operated in a non-contact mode, or optical detection of the sample deformation or expansion via surface light scattering or interferometry of shorter wavelength light.

In one or more scenarios, one or more techniques may comprise scanning the one or more time delays among the one or more constituent pulses to ascertain the one or more time delays.

In one or more scenarios, the one or more time delays may be controlled via at least one of: an interferometer, a beam-splitter and one or more retroreflectors, or a pulse shaper in the frequency domain.

In one or more scenarios, the one or more time delays may comprise at least two time delays, a first time delay and a second time delay, the first time delay and the second time delay being at least one of: a same time delay, or a different time delay.

In one or more scenarios, the recording the one or more signals as a function of the one or more time delays may utilize, at least in part, the scanned one or more time delays. In one or more scenarios, the recording the one or more signals as a function of the one or more time delays may form one or more interferograms.

In one or more scenarios, the IR laser source may be configured to generate broadband infrared (IR) light with a relatively short duration. In one or more scenarios, the extracting of photothermal 2D spectrum utilizes, at least in part, one or more Fourier transforms.

In one or more scenarios, the photothermal 2DIR spectroscopy may be conducted using, at least in part, one or more of: a Peak Force tapping (PFT) mode/pulsed force mode, an off-resonance tapping mode, or sub-resonance tapping mode.

In one or more scenarios, one or more techniques may comprise, in the PFT mode/pulsed force mode, causing an atomic force microscopy (AFM) tip to at least intermittently contact and detach from a sample surface.

In one or more scenarios, the photothermal 2DIR spectroscopy may be conducted using a contact mode causing an atomic force microscopy (AFM) tip to have at least a moment of contact with a sample surface.

In one or more scenarios, the photothermal 2DIR spectroscopy may be conducted using at least one of a tapping mode or a non-contact mode causing an atomic force microscopy (AFM) tip to be in proximity to the sample surface to sense the force generated due to the photothermal action of the sample.

In one or more scenarios, the one or more photothermal expansion mechanical actions cause oscillations in an atomic force microscopy (AFM) cantilever. The one or more signals may correspond to the one or more measured photothermal expansion mechanical actions being based, at least in part, on the oscillations in the AFM cantilever.

One or more systems for performing atomic force microscopy (AFM)-based photothermal two-dimensional infrared (2DIR) spectroscopy are disclosed herein. One or more systems may comprise an infrared (IR) laser source configured to provide IR light pulses. One or more systems may comprise a sequencer device configured to generate a pulse sequence from the IR light. The pulse sequence may comprise one or more time delays among one or more constituent pulses. One or more systems may comprise optics configured to focus the pulsed IR light on matter in a sample region. The pulsed IR light may interact with the matter in the sample region. One or more systems may comprise a detection device that may be configured to measure one or more photothermal expansion mechanical actions of the sample. One or more systems may comprise a computing device. The computing device may comprise a memory and/or a processor. The processor may be configured to detect the measured one or more photothermal expansion mechanical actions. The processor may be configured to create one or more signals corresponding to the one or more measured photothermal expansion mechanical actions. The processor may be configured to record the one or more signals as a function of the one or more time delays. The processor may be configured to extract at least a partial photothermal two-dimensional (2D) spectrum from the one or more signals as recorded as a function of the one or more time delays.

In one or more scenarios, the processor may be configured to scan the one or more time delays among the one or more constituent pulses to ascertain the one or more time delays.

In one or more scenarios, the one or more time delays may comprise at least two time delays, a first time delay and a second time delay. The first time delay and the second time delay may be at least one of: a same time delay, or a different time delay.

In one or more scenarios, the processor may be configured to record the one or more signals as a function of the one or more time delays utilizing, at least in part, the scanned one or more time delays.

In one or more scenarios, the processor may be configured such that the recorded one or more signals as a function of the one or more time delays form one or more interferograms. In one or more scenarios, the IR laser source may be configured to generate broadband infrared (IR) light with a relatively short duration.

In one or more scenarios, the processor may be configured to control at least one of: the IR laser source, the optics, the sequencer device, or the detection device. In one or more scenarios, the processor may be configured to implement detection of the photothermal expansion mechanical actions by control of an atomic force microscopy (AFM) tip to at least intermittently contact with a sample surface. The one or more photothermal expansion mechanical actions may cause oscillations in an AFM cantilever. The AFM tip may be attached to the AFM cantilever. The processor may be configured such that the one or more signals corresponding to the one or more measured photothermal expansion mechanical actions may be based, at least in part, on the oscillations in the AFM cantilever.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or might not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While operations may be depicted in the drawings in an order, this should not be understood as requiring that such operations be performed in the particular order shown and/or in sequential order, and/or that all illustrated operations be performed, to achieve useful outcomes. The described program components and/or systems can generally be integrated together in a single software product and/or packaged into multiple software products.

Examples of the subject matter described in this specification have been described. The actions recited in the claims can be performed in a different order and still achieve useful outcomes, unless expressly noted otherwise. For example, the processes depicted in the accompanying figures do not require the particular order shown, and/or sequential order, to achieve useful outcomes. Multitasking and parallel processing may be advantageous in one or more scenarios.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method of performing photothermal action-based two-dimensional infrared (2DIR) spectroscopy, the method comprising:
providing IR light pulses from an infrared (IR) laser source;
generating a pulse sequence from the IR light via a sequencer device, the pulse sequence comprising one or more time delays among one or more constituent pulses;
focusing the pulsed IR light on matter in a sample region, the pulsed IR light interacting with the matter in the sample region;
measuring one or more photothermal expansion mechanical actions in the matter of the sample region;
creating one or more signals corresponding to the one or more measured photothermal expansion mechanical actions;
recording the one or more signals as a function of the one or more time delays; and
extracting at least a partial photothermal two-dimensional (2D) spectrum from the one or more signals as recorded as a function of the one or more time delays.

2. The method of claim 1, further comprising detecting the one or more mechanical actions of the photothermal expansion on matter by an atomic force microscope via tip-sample contact.

3. The method of claim 1, further comprising detecting the one or more mechanical actions of the photothermal expansion on matter via at least one of: an atomic force microscope operated in a non-contact mode, or optical detection of the sample deformation or expansion via surface light scattering or interferometry of shorter wavelength light.

4. The method of claim 1, further comprising scanning the one or more time delays among the one or more constituent pulses to ascertain the one or more time delays.

5. The method of claim 1, wherein the one or more time delays are controlled via at least one of: an interferometer, a beam-splitter and one or more retroreflectors, or a pulse shaper in the frequency domain.

6. The method of claim 1, wherein the one or more time delays comprise at least two time delays, a first time delay and a second time delay, the first time delay and the second time delay being at least one of: a same time delay, or a different time delay.

7. The method of claim 4, wherein the recording the one or more signals as a function of the one or more time delays utilizes, at least in part, the scanned one or more time delays.

8. The method of claim 4, wherein the recording the one or more signals as a function of the one or more time delays forms one or more interferograms.

9. The method of claim 1, wherein the IR laser source is configured to generate broadband infrared (IR) light with a relatively short duration.

10. The method of claim 1, wherein the extracting of photothermal 2D spectrum utilizes, at least in part, one or more Fourier transforms.

11. The method of claim 1, wherein the photothermal 2DIR spectroscopy is conducted using, at least in part, one or more of: a Peak Force tapping (PFT) mode/pulsed force mode, an off-resonance tapping mode, or sub-resonance tapping mode.

12. The method of claim 11, further comprising, in the PFT mode/pulsed force mode, causing an atomic force microscopy (AFM) tip to at least intermittently contact and detach from a sample surface.

13. The method of claim 1, wherein the photothermal 2DIR spectroscopy is conducted using a contact mode causing an atomic force microscopy (AFM) tip to have at least a moment of contact with a sample surface.

14. The method of claim 1, wherein the photothermal 2DIR spectroscopy is conducted using at least one of a tapping mode or a non-contact mode causing an atomic force microscopy (AFM) tip to be in proximity to the sample surface to sense the force generated due to the photothermal action of the sample.

15. The method of claim 1, wherein the one or more photothermal expansion mechanical actions cause oscillations in an atomic force microscopy (AFM) cantilever, the one or more signals corresponding to the one or more measured photothermal expansion mechanical actions being based, at least in part, on the oscillations in the AFM cantilever.

16. A system for performing photothermal action-based two-dimensional infrared spectroscopy, the system comprising:
an infrared (IR) laser source configured to provide IR light pulses;
a sequencer device configured to generate a pulse sequence from the IR light, the pulse sequence comprising one or more time delays among one or more constituent pulses;
optics configured to focus the pulsed IR light on matter in a sample region, the pulsed IR light interacting with the matter in the sample region;
a detection device configured to measure one or more photothermal expansion mechanical actions of the sample; and
a computing device comprising:
a memory; and
a processor, the processor configured at least to:
detect the measured one or more photothermal expansion mechanical actions;
create one or more signals corresponding to the one or more measured photothermal expansion mechanical actions;
record the one or more signals as a function of the one or more time delays; and
extract at least a partial photothermal two-dimensional (2D) spectrum from the one or more signals as recorded as a function of the one or more time delays.

17. The system of claim 16, wherein the processor is further configured to scan the one or more time delays among the one or more constituent pulses to ascertain the one or more time delays.

18. The system of claim 16, wherein the one or more time delays comprise at least two time delays, a first time delay and a second time delay, the first time delay and the second time delay being at least one of: a same time delay, or a different time delay.

19. The system of claim 17, wherein the processor is further configured to record the one or more signals as a function of the one or more time delays utilizing, at least in part, the scanned one or more time delays.

20. The system of claim 17, wherein the processor is further configured such that the recorded one or more signals as a function of the one or more time delays form one or more interferograms.

21. The system of claim 16, wherein the IR laser source is configured to generate broadband infrared (IR) light with a relatively short duration.

22. The system of claim 16, wherein the processor is further configured to:
control at least one of: the IR laser source, the optics, the sequencer device, or the detection device; and
implement detection of the photothermal expansion mechanical actions by control of an atomic force microscopy (AFM) tip to at least intermittently contact with a sample surface, the one or more photothermal expansion mechanical actions causing oscillations in an AFM cantilever, the AFM tip being attached to the AFM cantilever, the processor being further configured such that the one or more signals corresponding to the one or more measured photothermal expansion mechanical actions are based, at least in part, on the oscillations in the AFM cantilever.
